(19) United States
(12) Patent Application Publication
(10) Pub. No.: US 2026/0361780 A1
(43) Pub. Date: Nov. 12, 2026

(54) CALL FLOW FOR SPATIAL COMPUTING

(71) Applicant: Tencent America LLC, Palo Alto, CA (US)

(72) Inventor: Stephan WENGER, Hillsborough, CA (US)

(73) Assignee: Tencent America LLC, Palo Alto, CA (US)

(21) Appl. No.: 19/654,358

(22) Filed: Apr. 21, 2026

Related U.S. Application Data
(60) Provisional application No. 63/804,591, filed on May 12, 2025.

(51) Int. Cl. H04L 65/60; H04L 65/1069

(52) U.S. Cl. CPC H04L 65/60; H04L 65/1069

(57) ABSTRACT

In a method of setting up a spatial computing session associated with a three-dimensional (3D) space, a spatial computing session request is transmitted to a media session handler of a media client by a spatial computing client of the media client in a user equipment (UE). When the media session handler receives the spatial computing session request transmitted from the spatial computing client, server information of a media application server and session parameters associated with the spatial computing session are determined by the media session handler of the UE based on communication between the media session handler and a media application function of a server. The server information and the session parameters are transmitted to a media access function of the UE by the media session handler to instantiate the spatial computing session.

### CROSS-REFERENCE TO RELATED APPLICATION

The present application claims the benefit of priority to U.S. Provisional Application No. 63/804,591, “CALL FLOW FOR SPATIAL COMPUTING” filed on May 12, 2025, which is incorporated by reference herein in its entirety.

### TECHNICAL FIELD

The present disclosure describes aspects generally related to spatial computing for augmented reality (AR) services.

### BACKGROUND

Extended reality (XR) spatial computing encompasses a set of functions which process sensor data to generate information about a world three-dimensional (3D) space surrounding an AR user. The set of functions include relocalization (e.g., establishing positions of users and objects within the world 3D space), anchoring, 3D Model construction, segmentation and labeling (e.g., semantic perception), light extraction, and real object removal. The set of functions are achieved through a combination of advanced sensors, cameras, and algorithms that enable devices (e.g., AR devices) to understand and interact with the 3D space around the devices.

A related example, information pertaining to a high-level call flow for spatial computing session setup and operation can be provided. However, the call flow may not be workable and usable for devices and services, as the call flow lacks at least certain aspects of session establishment. For example, the session establishment of the call flow lacks a mechanism for a media handler to announce session parameter options to a media application function (media AF).

### SUMMARY

Aspects of the disclosure include bitstreams, methods, and apparatuses for spatial computing. In some examples, an apparatus for spatial computing includes processing circuitry.

According to an aspect of the disclosure, a method of setting up a spatial computing session associated with a three-dimensional (3D) space is provided. In the method, a spatial computing session request is transmitted to a media session handler of a media client by a spatial computing client of the media client in a user equipment (UE). The spatial computing session request is configured to request setup of the spatial computing session of spatial computing. When the media session handler receives the spatial computing session request transmitted from the spatial computing client, server information of a media application server and session parameters associated with the spatial computing session are determined by the media session handler based on communication between the media session handler and a media application function of a server. The server information and the session parameters are transmitted to a media access function of the UE by the media session handler to instantiate the spatial computing session.

In an aspect, the spatial computing session request is initiated by a media-aware application of the UE that transmits the spatial computing session request to the spatial computing client.

In an aspect, one or more configurations of the spatial computing session are received by the media session handler. The one or more configurations are transmitted from the media application function and are determined based on the determined session parameters.

In an aspect, the spatial computing session with the media application server are established by the media access function based on the determined session parameters of the spatial computing session.

In an aspect, the one or more configurations are transmitted to the media session handler and the media application server by the media application function. The media application server sets up the spatial computing session based on the one or more configurations.

In an aspect, the session parameters include at least one of extended reality (XR) spatial description formats, quality of service (QoS) requirements, or spatial computing capabilities of the UE.

In an aspect, the media-aware application, the media session handler, and the media access function are included in the media client. The media application server is included in a data network and configured to establish the spatial computing session with the media client.

In an aspect, the media session handler is configured to set up and manage a plurality of spatial computing sessions associated with the 3D space.

In an aspect, the media application function is configured to communicate with the media session handler and the media application server.

In an aspect, an XR runtime of the UE is configured to provide sensor data by the media-aware application. The sensor data is required by a plurality of spatial computing functions that is to be processed in the media application server.

In an aspect, the server that includes the media application function is the media application server.

In an aspect, the server that includes the media application function is different from the media application server.

In an aspect, the spatial computing session is of spatial computing for augmented reality.

Aspects of the disclosure also provide an apparatus for spatial computing. The apparatus for spatial computing including processing circuitry configured to implement any of the described methods for spatial computing.

Aspects of the disclosure also provide a non-transitory computer-readable storage medium stores instructions which, when executed by at least one processor of a UE, cause the at least one processor to perform any of the described methods for spatial computing.

Technical solutions of the disclosure include methods and apparatuses for session establishment and session parameter option announcement from a media session handler to a media application function, thereby enhancing a call flow for spatial computing. In an example, a spatial computing session request is transmitted to a media session handler of a media client by a spatial computing client of the media client in a UE. The spatial computing session request is configured to request setup of the spatial computing session of spatial computing. When the media session handler receives the spatial computing session request transmitted from the spatial computing client, server information of a media application server and session parameters associated with the spatial computing session are determined by the media session handler based on communication between the media session handler and a media application function of a server. The server information and the session parameters are transmitted to a media access function of the UE by the media session handler to instantiate the spatial computing session. Accordingly, capability and functionality of the spatial computing are enhanced by introducing the session establishment and session parameter option announcement from the media session handler to the media application function.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of an extended reality (XR) baseline terminal architecture according to some aspects of the disclosure.

FIG. 2 is a schematic illustration of an example of a spatial computing architecture according to some aspects of the disclosure.

FIG. 3 is a schematic illustration of an example of a call flow for spatial computing session setup and operation.

FIG. 4 shows a flow chart outlining a first method for performing spatial computing according to some aspects of the disclosure.

FIG. 5 is a schematic illustration of a computer system in accordance with an aspect.

### DETAILED DESCRIPTION

Aspects of the disclosure include a call flow for spatial computing (e.g., XR spatial computing) based on, for example, a previous workflow described in 3GPP TR 26.819 v0.4.0. A plurality of steps are added to the previous workflow to make systems and services usable and workable.

XR spatial computing requires accurately localizing an AR device worn by an end-user in relation to a spatial coordinate system of a real-world space. Vision-based localization systems reconstruct a sparse spatial mapping of the real-world space in parallel (e.g., simultaneous localization and mapping (SLAM)). Beyond the localization within a world coordinate system, which may be based on a sparse spatial map, dense spatial mapping of objects is also beneficial in order to place 3D objects on real surfaces and provides ability to occlude objects behind surfaces, do physics-based interactions based on surface properties, provide navigation functions, or provide a visualization of the surface.

In an aspect, for purpose of understanding and perceiving a scene semantically, machine-learning and/or artificial intelligence may be used to provide context for the observed scene.

An output of spatial computing may include spatial mapping information that is organized in a data structure, such as a data structure called XR Spatial Description, for storing and exchanging the spatial mapping information. Some spatial computing functions may also take an XR spatial description as an input and may result in updates to the XR spatial description. Spatial computing functions may include data exchange and require a network architecture.

An AR device may provide sensor data to a spatial computing function to create or update spatial mapping information. The AR device may also access the spatial computing function to retrieve different spatial mapping information depending on needs of the XR application.

The spatial computing functions may run locally on the AR device or may be executed remotely on a cloud or on an edge in a spatial computing server accessed through dedicated interfaces.

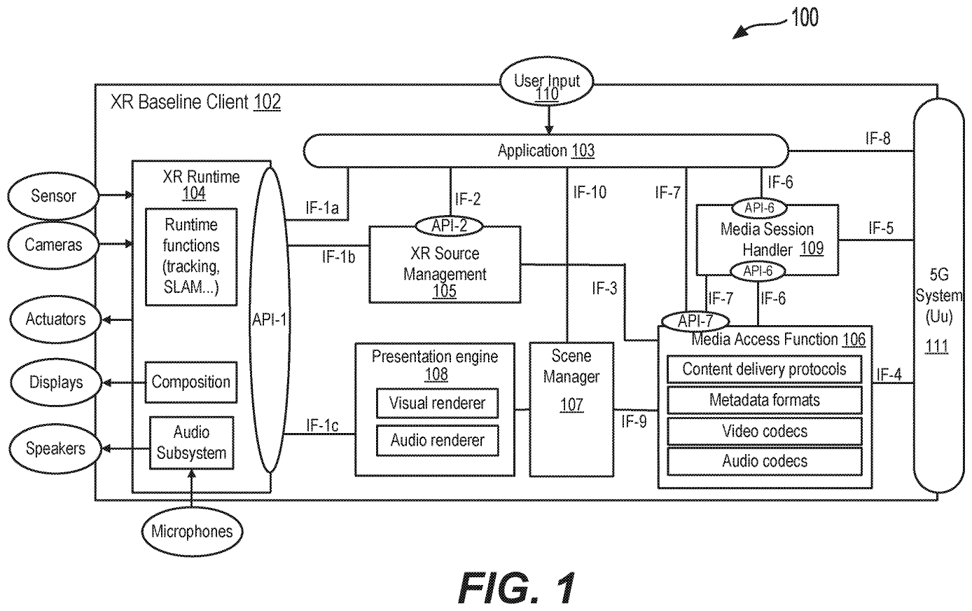

FIG. 1 is a schematic illustration of an example of an XR baseline terminal architecture (100) for spatial computing according to some aspects of the disclosure.

As shown in FIG. 1, the XR baseline terminal architecture (100) may include an XR baseline client (102). The XR baseline client (102) may include an XR application (or application) (103), an XR runtime (104), XR source management (105), a media access function (106), a scene manager (107), a presentation engine (108), and a media session handler (109).

The XR application (103) may include a software application that receives a user input (110) of a user and integrates an audio-visual content into a real-world environment of the user. The XR runtime (104) may include a set of functions that interface with a platform to perform commonly needed operations, such as accessing a controller/peripheral state, getting current and/or predicted tracking positions, performing spatial computing, as well as submitting (i) rendered frames to a display processing unit and (ii) a rendered audio to speakers with a late stage re-projection to a latest pose. In an example, the set of functions is provided by an XR device (or AR device) to the XR application to support XR experiences. The XR runtime (104) may include one or more spatial computing functions that can be performed locally on the XR device.

The XR source management (105) may include management of data sources provided through the XR runtime (104), such as microphones, cameras, trackers, etc., for instance, making the data sources available to the XR application (103) or providing the data sources to the media access function (106) for sending the data sources in an uplink of a 5G system (111). In an example, the XR source management (105) is responsible for gathering timed metadata, such as sensor data and pre-processed sensor information, and sending the timed metadata to an application server (AS).

The media access function (106) may include a set of functions that enable access to media and other XR-related data that is needed in the scene manager (107) or the XR runtime (104) to provide an XR experience as well as to create delivery formats for information provided by the XR source management (105). In an aspect, the media access function (106) is responsible for delivery of metadata or local media to the spatial computing functions in an application server (AS).

The scene manager (107) may include a set of functions that support the application (103) in arranging logical and spatial representation of a multisensorial scene based on support from the XR runtime (104). The presentation engine (108) may include a set of composite renderers (e.g., a visual renderer and an audio renderer), rendering components of scenes, based on an input from the scene manager (107). In an example, the scene manager (107) and the presentation engine (108) are responsible for parsing of a description (e.g., XR spatial description) that is returned as an output from one or more spatial computing functions. The spatial computing functions may be provided by the AS. The scene manager (107) and the presentation engine (108) are also configured to set up and manage an XR session with the XR runtime (104).

The media session handler (109) may include a set of functions responsible for handling all 5G control plane operations, such as requesting network assistance, discovering and allocating edge resources, etc. The media session handler (109) may be realized as a 5G-RTC MSH, 5GMS Media Session Handler, or any other function.

In an aspect, functional blocks shown in FIG. 1 may be integrated together via interfaces. Interfaces may include application programming interfaces (APIs) and/or data formats, collectively serving as a contract between parties on each side of the interface.

In an example of FIG. 1, the XR baseline client (102) includes a plurality of interfaces, such as interfaces IF-1, IF-2, IF-3, IF-4, IF-5, IF-6, IF-7, IF-8, IF-9, and IF-10. IF-1 includes an interface IF-1a between the XR runtime (104) and the application (103), an interface IF-1b between the XR runtime (104) and the XR source management (105), and an interface IF-1c between the XR runtime (104) and the presentation engine (108). In an example, the interfaces IF-1a, IF-1b, and IF-1c are implemented as an application programming interface (API), such as API-1, that exposes functions provided by the XR runtime (104). An example of the API is Khronos OpenXR API. IF-2 may describe functions exposed by the XR source management (105). The functions may be accessed and controlled by the XR application (103), or other functions in a device (e.g., an AR device or an XR device). In an example, IF-2 is implemented as API-2. IF-3 is defined between the XR source management (105) and the media access function (MAF) (106). IF-3 may be configured to provide serialized information accessible on (or originating from) the XR runtime (104) to the MAF (106). IF-4 is defined between the media access function (106) and the 5G System (111) for transmitting user plane data, such as application data or other graphics data needed by the XR application (103). IF-5 is defined between a user equipment (UE) and the 5G System (111) and configured to implement control sessions. In an example, the UE includes one of an AR device, an extended reality (XR) device, and an edge computing device (e.g., a media application server).

An example of IF-5 is a RTC-5 interface as defined by 3GPP TS 26.506. IF-6 connects the media session handler (109) and the application (103) and/or the MAF (106). IF-6 offers tools for the application (103) and/or the MAF (106) to activate a 5G media functionality, such as a network assistance and an edge resource discovery. In an example, IF-6 is realized through an API, such as API-6. IF-7 lies between the XR application (103) and the media access function (106) to configure media access. IF-7 may be implemented as an API, such as API-7, that exposes functions of the MAF (106). IF-8 is an interface that allows the XR application (103) to make use of connectivity of the 5G system (111). IF-9 is an interface between the scene manager (107) and the MAF (106). IF-10 is defined between the scene manager (107) and the XR application (103).

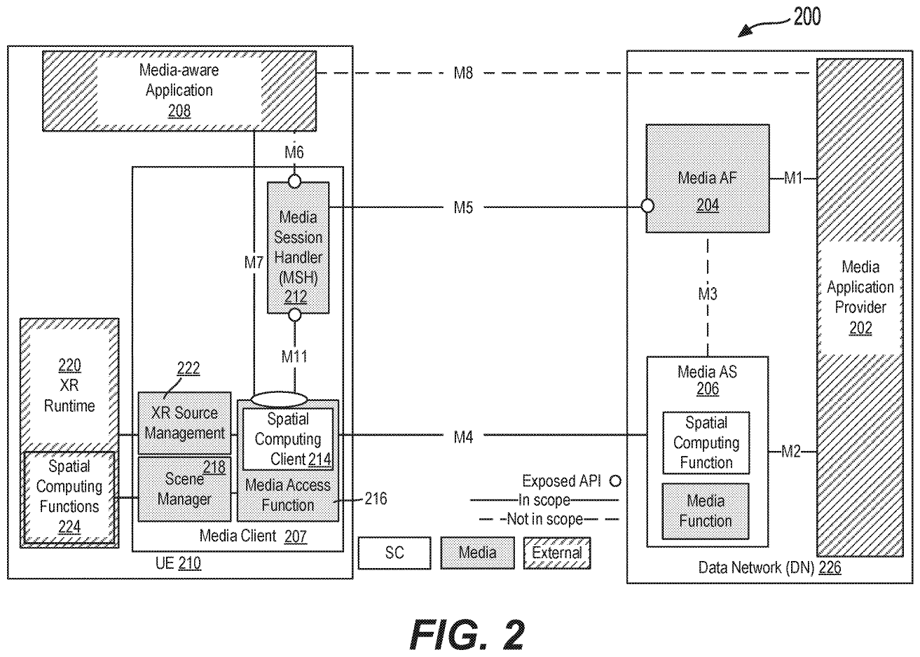

FIG. 2 is a schematic illustration of an example of a spatial computing architecture (200) (also referred to as architecture (200)) based on a user equipment (UE) (210) and a data network (DN) (226).

As shown in FIG. 2, the spatial computing architecture (200) includes a plurality of network functions and UE entities. For example, the architecture (200) includes a media application provider (202) that is configured to offer a spatial computing service. The architecture (200) includes a media application function (media AF) (204) that is responsible for negotiation of a spatial computing service session between a media application server (media AS) (206) and a media client (207).

The media AS (206) included in the architecture (200) is responsible for establishing the spatial computing session with the media client and monitoring an edge resource usage of the media application server (206). The media AS (206) may host a spatial computing function that manages and runs one or more other spatial computing functions.

The architecture (200) includes a media-aware application (208) that includes one or more applications running on the UE (210). The architecture includes a media session handler (MSH) (212). The MSH (212) is located on the UE (210) and configured to manage control plane signaling with the media AF (204) to establish a spatial computing session.

The architecture (200) includes a spatial computing client (SCC) (214) that is responsible for discovering UE spatial computing capabilities and negotiating with the media AS (206) to agree on a spatial computing process.

The architecture (200) includes a media access function (216) (e.g., a media access function defined in 3GPP TS 26.506), configured to send sensor data and receive XR spatial descriptions from the media AS (206).

In an example, the sensor data includes images captured by an AR device, inertial measurement unit (IMU) data, a pose of the AR device, depth maps (e.g., image or texture), global navigation satellite system (GNSS) data, depth data (e.g., LiDAR data), mesh data captured by the AR device, or the like.

The architecture (200) includes a scene manager (218). The scene manager (218) may include a set of functions that supports an application in arranging a logical and spatial representation of a multisensorial scene based on support from an XR runtime (220). The scene manager (218) may compose a scene using XR spatial description data.

The architecture (200) includes XR source management (222) that includes management of data sources provided through the XR runtime (220). The XR source management may retrieve the sensor data (and/or other data, such as camera data, microphone data) from the XR runtime (220) and provides the sensor data to the media access function (216).

The XR runtime (220) of the architecture (200) includes a set of functions provided by an XR device to the media application (208) to create XR experiences. The XR runtime (220) may include one or more spatial computing functions (224).

Still referring to FIG. 2, the architecture (200) may include a plurality of interfaces, such as interfaces M1-M8 and M11. In an aspect, the media application provider (202) may provide a spatial computing service through the M-1 interface. In an aspect, signaling as well as data delivery between media access function (216) and the media AS (206) is through the M-4 interface. In an aspect, the MSH (212) and the media AF (204) may exchange spatial computing configuration related information through the M-5 interface. In an aspect, the spatial computing client (214) may discover the spatial computing capabilities of the UE through the M-7 interface. In an aspect, the M11 interface may be used to convey quality of service (QoS) allocation and quality of experience (QoE) information related to spatial computing functions between the MSH (212) and the media access function (216).

Aspects of the disclosure include a workflow that improves a previous workflow provided in a related example, such as 3GPP TR 26.819 v0.4.0. The workflow of the current disclosure may be executed by a processor in a media client (e.g., media client (207)) and at least one processor in a media application function (e.g., media AF (204)) and a media application server (e.g., media AS (206)). The media client may include a smartphone, an XR device, AR glasses, an XR phone, or an XR head mounted display (HMD). The workflow may include one or more steps to perform a desired function. The one or more steps may include (i) session initialization (or wakeup) by a spatial computing client in the media client to a media session handler, (ii) parameter negotiation, (iii) configuration selection, and (iv) instantiation of a request based on the selected configuration.

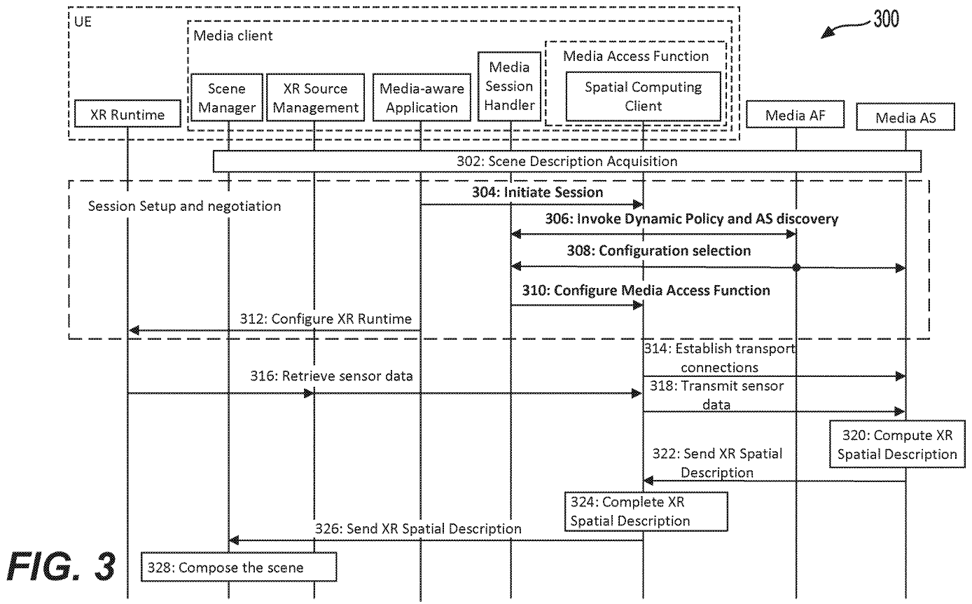

FIG. 3 is a schematic illustration of an example of a call flow (or workflow) (300) for spatial computing session setup and operation.

As shown in FIG. 3, in an aspect, the workflow (300) involves several functional hardware and software entities that may be present in a 3GPP-based system to support an extended reality (XR) application in a user equipment-based media client (e.g., a smartphone (UE)-based media client) and a server. Functions of various building blocks and protocol elements shown in FIG. 3 may be documented (or discussed) in a related example, such as 3GPP TR 26.819 v0.4.0. The present disclosure includes aspects directed to addressing certain shortcomings of the related example. For example, a session setup in the workflow of the related example may be impractical and unworkable. Thus, modifications and additions may be required to address shortcomings in the session setup of the workflow in the related example.

In an aspect of the disclosure, one or more spatial computing functions may be initialized during a 5G media streaming session. A media session handler (MSH) (e.g., MSH (212)) in the media client (e.g., media client (207)) may be configured to perform signaling and negotiation, such as control plane signaling and negotiation, with a media application function (e.g., media AF (204)) in a server. The MSH and the media AF may not directly execute the spatial computing functions but may play a key role in enabling or configuring the spatial computing functions.

Still referring to FIG. 3, the workflow (300) starts with step (302). At step (302), a scene manager, such as the scene manager (218), acquires scene description information and discovers needed spatial computing functions for XR experience.

In an aspect, at step (304), the media-aware application (e.g., (208)) may initiate a session by configuring the media access function (MAF) at a reference point, such as at the reference point M7 in FIG. 2. For example, the media-aware application informs the media access function what the media-aware application needs and how the session should operate, so that the media access function can properly manage the media delivery. The MAF may further inform the media session handler about the session and retrieves relevant policy and configuration information.

In another aspect, at step (304), a spatial computing client (e.g., spatial computing client (214)) may initiate a session (or spatial computing session) by contacting a media session handler (e.g., MSH (212)), which acts as a control plane interface. Both software entities (e.g., the spatial computing client and the media session handler) may be a part of software on a UE (e.g., a smartphone, an XR device, AR glasses, an XR phone, or an XR head mounted display (HMD)). In an aspect, initiation of the session may not be visible by observing bits exchanged between the client and the server.

The media session handler may be a functional module responsible for setup and management of all media sessions and may perform tasks common to IP multimedia subsystem (IMS)-based call setup. For example, the media session handler may manage session initiation protocol (SIP) implementation. The initiation shown at step (304) may take a form of a “wakeup” of the media session handler in certain message based operating systems. The message may include certain initial characteristics of spatial computing requests that trigger the initiation.

The spatial computing requests may include requests to the server to perform: (1) world tracking; (2) relocalization, which may include negotiation of a pose format, a reference ID, a use of GNSS, or the like; (3) anchoring, which may include support for one or more of persistent anchors, trackable types, and synchronization; (4) 3D model construction, which may include negotiation of a mesh format (e.g., glTF, USD, resolution, update frequency, etc.); (5) segmentation and labeling, which may include negotiating a label ontology and an output format (e.g., a hierarchical graph); (6) light extraction, which may include negotiation of supported light types; (7) semantic perception, which may include information pertaining to a need and/or a use of AI/ML-based scene understanding; (8) collider generation, which may include negotiation on a use and a data format of colliders (e.g., a simple mesh); and (9) real object removal, which may include negotiation of whether a diminished reality is supported and what inpainting methods may be used.

According to an aspect, at step (306), the media session handler communicates with the media AF for the AS discovery (in a case of edge computing) and configuration of quality-of-service parameters at a reference point, such as at reference point M5 in FIG. 2. In an example, AS discovery refers to application server discovery, which is a process that the media session handler identifies and locates an appropriate application server (e.g., media AS (206)) to handle the media session.

According to another aspect, at step (306), the media session handler (e.g., media session handler (212)) may communicate over a 3GPP network (e.g., DN (226)) with the media application function (e.g., media application function (204)) located in a server in the network (e.g., the DN (226)). In an example, the media application function may be located near a network edge of the network. The communication between the media session handler and the media application function may use any suitable communication protocol (e.g., SIP) that is advantageously standardized by 3GPP so as to help ensure multi-vendor interoperability. Session parameters may be negotiated during the communication. The session parameters may include aforementioned requests (e.g., spatial computing requests) codified in a suitable form, XR spatial description formats, quality of service (QoS) requirements, and spatial computing capabilities.

The media application function may coordinate with the media application server (e.g., media application server (206)). The media application server may be located in the network (e.g., DN (226)), such as close to the edge of the network. In an example, the media application server may be different from the server in which the media application function is positioned. In an example, the media application server may be the server in which the media application function is positioned. A scope of the coordination may include creating one or more suitable configurations that enable the media application server to support the client (e.g., media client (207)) to handle the media (or the spatial computing sessions).

At step (308), once one or more configurations for spatial computing functions (or spatial computing session) are determined, the media application function and the media session handler may negotiate to select configurations based on the determined session parameters in step (306). The media application server may be informed of the selected configurations and potentially influence the negotiation of the configuration selection. The process in step (308) may entail the media application function selecting an appropriate configuration and instructing the media application server to prepare for the session. The media application function may also inform the media session handler of the selected formats and configurations. In an example, the configuration for the spatial computing function refers to the settings, parameters, or options that define how spatial computing features operate within a system or session.

According to an aspect, at step (310), the media session handler passes the information configured in step (306) to the media access function via an interface, such as via the interfaces M6/M11 in FIG. 2.

According to another aspect, at step (310), based on the selected formats and configurations, the media session handler may relay the configurations to the spatial computing client. Subsequently, the spatial computing client may request instantiation of spatial computing pipelines via the media access function.

At step (312), an XR runtime (e.g., XR runtime (220)) is configured.

Configuration of the XR runtime may aim to provide sensor data (or other data, such as camera data and microphone data) that is needed for the spatial computing functions configured in the media AS at step (308).

In an example of step (312), the media-aware application (e.g., media-aware application (208)) configures the XR Runtime. This configuration may enable the XR Runtime to provide sensor and control data needed for the spatial computing functions. Sensor data may include, for example, a pose of the AR device. Control data may include, for example, coordinates of a bounding volume to request from the Media AS as a spatial region of interest, such as a subset of 3D world model.

At step (314), the spatial computing client requests an instantiation of pipelines for XR spatial description from the media access function, which in turn establishes a connection to the media AS.

At step (316), XR source management (e.g., XR source management (222)) retrieves the sensor data from the XR runtime and provides the sensor data to the media access function (e.g., the media access function (216)).

At step (318), the media access function sends the sensor data to the media AS.

At step (320), the media AS uses the sensor data to invoke the spatial computing functions and compute the XR spatial description. In an example, an output of spatial computing based on the spatial computing functions may include spatial mapping information that is organized in a data structure, such as a data structure called XR spatial description, for storing and exchanging the spatial mapping information.

At step (322), the media AS transmits the generated XR spatial description to the media access function.

At step (324), the spatial computing client may complete the XR spatial description using the sensor data.

At step (326), the spatial computing client provides the XR spatial description to a scene manager (e.g., scene manager (218)).

At step (328), the scene manager composes a scene using the XR spatial description.

In an aspect, the spatial computing functions include a world tracking function, a relocalization function, an anchoring function, a 3D model reconstruction function, a segmentation and labeling function, a collider generation function, a light extraction function, and a real object removal function. Examples of the spatial computing functions and output of the spatial computing functions are provided in Table 1.

TABLE 1
Spatial computing functions and associated output data

| | | | | Possible |
|---|---|---|---|---|
| Function | Data | Description | Format Example | Representation |
| World | Feature Map | Features to compute a | Array of features | |
| Tracking | | pose in XR Space. | | |
| | Feature | 3D point associated | SIFT (Scale | Typically, a |
| | | with a descriptor, the | Invariant Feature | vector of 128 |
| | | descriptor format | Transform) | floats. |
| | | depends on the | ORB - Oriented | Typically, a 32- |
| | | feature type. | FAST Rotated | bit descriptor. |
| | | | BRIEF (Binary | |
| | | | descriptor) | |
| | | | BRIEF - Binary | Typically, 32- |
| | | | Robust | bit descriptor. |
| | | | Independent | |
| | | | Elementary | |
| | | | Features) | |
| | | | FREAK - Fast | Typically, 64- |
| | | | Retina Keypoint | bit descriptor. |
| | | | SURF - Speeded- | Typically, |
| | | | Up Robust | vector of 64-bit |
| | | | Features | or 128-bit |
| | | | | floats. |
| Relocalization | Pose | Pose of the AR | Position: 3D | Position: 3 |
| | | device in XR Space | vector | floating point |
| | | | Orientation: | values. |
| | | | quaternion | Orientation: 4 |
| | | | | floating point |
| | | | | values |
| | XR_space_id | An identifier for the | String | |
| | | XR Space used as a | | |
| | | reference. | | |
| Anchoring | Id | An identifier of the | String | |
| | | new trackable (when | | |
| | | the anchoring | | |
| | | function is invoked | | |
| | | by a producer). | | |
| | Pose | Pose of the anchor in | Position: 3D | Position: 3 |
| | | relation to the device | vector | floating point |
| | | according to a | Orientation: | values. |
| | | trackable (when the | quaternion | Orientation: 4 |
| | | anchoring function is | | floating point |
| | | invoked by a | | values |
| | | consumer). | | |
| 3D Model | Model | 3D model(s) of | Non-segmented | OBJ, STL, PLY |
| Construction | | surrounding space. | model (e.g., point | [41], FBX, |
| | | | cloud, mesh | glTF |
| | | | with/without | |
| | | | attributes) | |
| | | | Segmented model | glTF, USD |
| Collider | Colliders | Set of colliders (not | Array of colliders | |
| Generation | | combined with | | |
| | | associated objects). | | |
| | Collider | A collider object. | Primitive (e.g., | |
| | | | sphere with | |
| | | | radius) | |
| | | | Mesh | OBJ, STL, |
| | | | | FBX |
| | Colliders | Part of description of | Hierarchical node | MPEG-I SD, |
| | | the 3D Model (when | graph | USD [46] |
| | | combined with | | |
| | | associated objects). | | |
| Segmentation | Objects | A list of 3D objects | Array or a | |
| and Labeling | | resulting from the | hierarchical node | |
| | | segmentation and | graph. | |
| | | labeling function. | | |
| | Object | A 3D object in the | | |
| | | captured world. | | |
| | Mesh | Segmented object. | Mesh | |
| | Label | Label of segmented | String | |
| | | object. | | |
| Light | Lights | Set of extracted lights | Array | |
| Extraction | Light | A description of a | Object | For point light, |
| | | light source that | | the parameters |
| | | includes a set of | | include: pose, |
| | | parameters that | | intensity, color, |
| | | depend on the type of | | and range. |
| | | the light. Possible | | |
| | | types include: point, | | |
| | | directional, area, | | |
| | | spot, texture-based, | | |
| | | or image-based light. | | |
| Real Object | Objects | A set of textured 3D | Mesh + texture | OBJ, STL, |
| Removal | | objects. | | PLY, FBX, |
| | | | | glTF |
| | Images | Images with | | PNG, TIFF, |
| | | transparency. | | TGA, BMP |

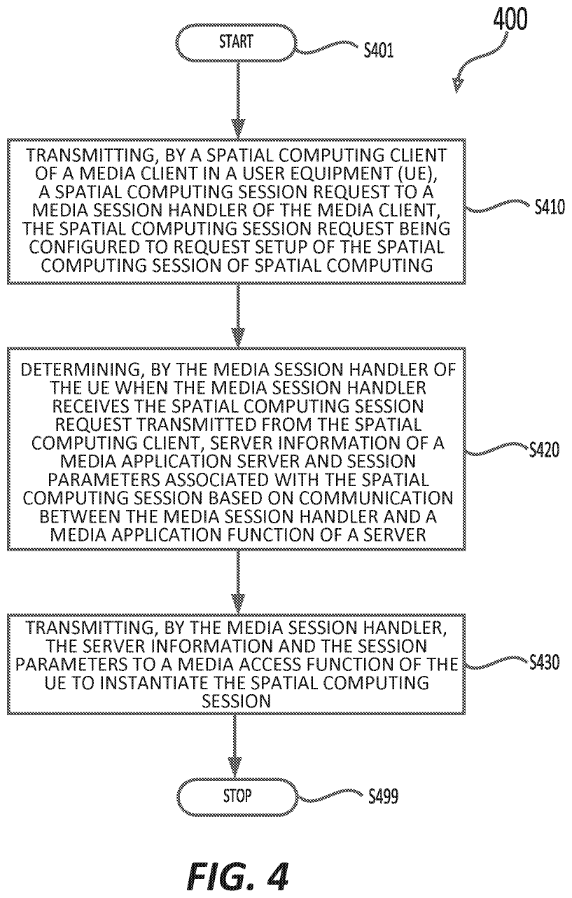

FIG. 4 shows a flow chart outlining a process (400) according to an aspect of the disclosure. The process (400) can be used in a UE. In various aspects, the process (400) is executed by processing circuitry, such as the processing circuitry that performs functions of the UE (210). In some aspects, the process (400) is implemented in software instructions, thus when the processing circuitry executes the software instructions, the processing circuitry performs the process (400). The process starts at (S401) and proceeds to (S410).

At (S410), a spatial computing session request is transmitted to a media session handler of a media client by a spatial computing client of the media client in a user equipment (UE). The spatial computing session request is configured to request setup of the spatial computing session of spatial computing.

At (S420), when the media session handler receives the spatial computing session request transmitted from the spatial computing client, server information of a media application server and session parameters associated with the spatial computing session are determined by the media session handler based on communication between the media session handler and a media application function of a server.

At (S430), the server information and the session parameters are transmitted to a media access function of the UE by the media session handler to instantiate the spatial computing session.

In an aspect, the spatial computing session request is initiated by a media-aware application of the UE that transmits the spatial computing session request to the spatial computing client.

In an aspect, one or more configurations of the spatial computing session are received by the media session handler. The one or more configurations are transmitted from the media application function and are determined based on the determined session parameters.

In an aspect, the spatial computing session with the media application server are established by the media access function based on the determined session parameters of the spatial computing session.

In an aspect, the one or more configurations are transmitted to the media session handler and the media application server by the media application function. The media application server sets up the spatial computing session based on the one or more configurations.

In an aspect, the session parameters include at least one of extended reality (XR) spatial description formats, quality of service (QoS) requirements, or spatial computing capabilities of the UE.

In an aspect, the media-aware application, the media session handler, and the media access function are included in the media client. The media application server is included in a data network and configured to establish the spatial computing session with the media client.

In an aspect, the media session handler is configured to set up and manage a plurality of spatial computing sessions associated with the 3D space.

In an aspect, the media application function is configured to communicate with the media session handler and the media application server.

In an aspect, an XR runtime of the UE is configured to provide sensor data by the media-aware application. The sensor data is required by a plurality of spatial computing functions that is to be processed in the media application server.

In an aspect, the server that includes the media application function is the media application server.

In an aspect, the server that includes the media application function is different from the media application server.

In an aspect, the spatial computing session is of spatial computing for augmented reality.

Then, the process proceeds to (S499) and terminates.

The process (400) can be suitably adapted. Step(s) in the process (400) can be modified and/or omitted. Additional step(s) can be added. Any suitable order of implementation can be used.

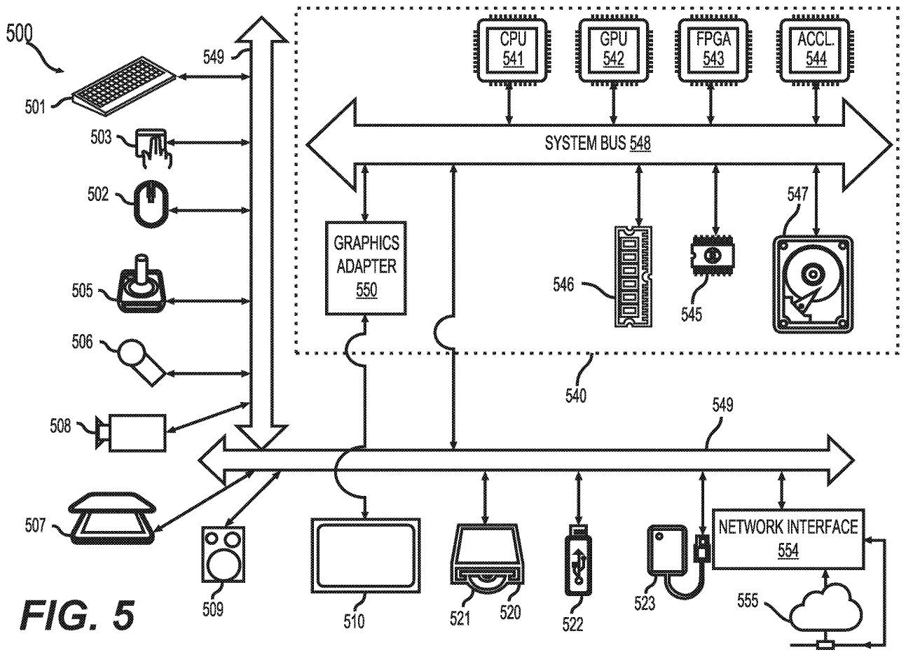

The techniques described above, can be implemented as computer software using computer-readable instructions and physically stored in one or more computer-readable media. For example, FIG. 5 shows a computer system (500) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 5 for computer system (500) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (500).

Computer system (500) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (501), mouse (502), trackpad (503), touch screen (510), data-glove (not shown), joystick (505), microphone (506), scanner (507), camera (508).

Computer system (500) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (510), data-glove (not shown), or joystick (505), but there can also be tactile feedback devices that do not serve as input devices), audio output devices (such as: speakers (509), headphones (not depicted)), visual output devices (such as screens (510) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (500) can also include human accessible storage devices and their associated media such as optical media including CD/DVD ROM/RW (520) with CD/DVD or the like media (521), thumb-drive (522), removable hard drive or solid state drive (523), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (500) can also include an interface (554) to one or more communication networks (555). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (549) (such as, for example USB ports of the computer system (500)); others are commonly integrated into the core of the computer system (500) by attachment to a system bus as described below (for example Ethernet interface into a PC computer system or cellular network interface into a smartphone computer system). Using any of these networks, computer system (500) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (540) of the computer system (500).

The core (540) can include one or more Central Processing Units (CPU) (541), Graphics Processing Units (GPU) (542), specialized programmable processing units in the form of Field Programmable Gate Areas (FPGA) (543), hardware accelerators for certain tasks (544), graphics adapters (550), and so forth. These devices, along with Read-only memory (ROM) (545), Random-access memory (546), internal mass storage such as internal non-user accessible hard drives, SSDs, and the like (547), may be connected through a system bus (548). In some computer systems, the system bus (548) can be accessible in the form of one or more physical plugs to enable extensions by additional CPUs, GPU, and the like. The peripheral devices can be attached either directly to the core's system bus (548), or through a peripheral bus (549). In an example, the screen (510) can be connected to the graphics adapter (550). Architectures for a peripheral bus include PCI, USB, and the like.

CPUs (541), GPUs (542), FPGAs (543), and accelerators (544) can execute certain instructions that, in combination, can make up the aforementioned computer code. That computer code can be stored in ROM (545) or RAM (546). Transitional data can also be stored in RAM (546), whereas permanent data can be stored for example, in the internal mass storage (547). Fast storage and retrieve to any of the memory devices can be enabled through the use of cache memory, that can be closely associated with one or more CPU (541), GPU (542), mass storage (547), ROM (545), RAM (546), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (500), and specifically the core (540) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (540) that are of non-transitory nature, such as core-internal mass storage (547) or ROM (545). The software implementing various aspects of the present disclosure can be stored in such devices and executed by core (540). A computer-readable medium can include one or more memory devices or chips, according to particular needs. The software can cause the core (540) and specifically the processors therein (including CPU, GPU, FPGA, and the like) to execute particular processes or particular parts of particular processes described herein, including defining data structures stored in RAM (546) and modifying such data structures according to the processes defined by the software. In addition or as an alternative, the computer system can provide functionality as a result of logic hardwired or otherwise embodied in a circuit (for example: accelerator (544)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C, or any combination thereof. References to one of A or B and one of A and B are intended to include A or B or (A and B). The use of “one of” does not preclude any combination of the recited elements when applicable, such as when the elements are not mutually exclusive.

The structures in FIG. 2, such as the media AF (204), the media AS (206), the MSH (212), and the XR runtime (220), may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method of setting up a spatial computing session associated with a three-dimensional (3D) space, the method including: transmitting, by a spatial computing client of a media client in a user equipment (UE), a spatial computing session request to a media session handler of the media client, the spatial computing session request being configured to request setup of the spatial computing session of spatial computing; determining, by the media session handler of the UE when the media session handler receives the spatial computing session request transmitted from the spatial computing client, server information of a media application server and session parameters associated with the spatial computing session based on communication between the media session handler and a media application function of a server; and transmitting, by the media session handler, the server information and the session parameters to a media access function of the UE to instantiate the spatial computing session.

(2) The method of feature (1), in which the spatial computing session request is initiated by a media-aware application of the UE that transmits the spatial computing session request to the spatial computing client.

(3) The method of feature (1) or (2), further including: receiving, by the media session handler, one or more configurations of the spatial computing session transmitted from the media application function based on the determined session parameters.

(4) The method of any one of features (1) to (3), further including: establishing, by the media access function, the spatial computing session with the media application server based on the determined session parameters of the spatial computing session.

(5) The method of feature (3), in which: the one or more configurations are transmitted to the media session handler and the media application server by the media application function; and the media application server sets up the spatial computing session based on the one or more configurations.

(6) The method of any one of features (1) to (5), in which the session parameters include at least one of extended reality (XR) spatial description formats, quality of service (QoS) requirements, or spatial computing capabilities of the UE.

(7) The method of feature (2), in which: the media-aware application, the media session handler, and the media access function are included in the media client, and the media application server is included in a data network and configured to establish the spatial computing session with the media client.

(8) The method of any one of features (1) to (7), in which the media session handler is configured to set up and manage a plurality of spatial computing sessions associated with the 3D space.

(9) The method of any one of features (1) to (8), in which the media application function is configured to communicate with the media session handler and the media application server.

(10) The method of feature (2), further including: configuring, by the media-aware application, an XR runtime of the UE to provide sensor data required by a plurality of spatial computing functions that is to be processed in the media application server.

(11) The method of any one of features (1) to (10), in which the server that includes the media application function is the media application server.

(12) The method of any one of features (1) to (11), in which the server that includes the media application function is different from the media application server.

(13) The method of any one of features (1) to (12), in which the spatial computing session is of spatial computing for augmented reality.

(14) An apparatus for spatial computing, including processing circuitry that is configured to perform the method of any one of features (1) to (13).

What is claimed is:

1. A method of setting up a spatial computing session associated with a three-dimensional (3D) space, the method comprising:
transmitting, by a spatial computing client of a media client in a user equipment (UE), a spatial computing session request to a media session handler of the media client, the spatial computing session request being configured to request setup of the spatial computing session of spatial computing;
determining, by the media session handler of the UE when the media session handler receives the spatial computing session request transmitted from the spatial computing client, server information of a media application server and session parameters associated with the spatial computing session based on communication between the media session handler and a media application function of a server; and
transmitting, by the media session handler, the server information and the session parameters to a media access function of the UE to instantiate the spatial computing session.

2. The method of claim 1, wherein the spatial computing session request is initiated by a media-aware application of the UE that transmits the spatial computing session request to the spatial computing client.

3. The method of claim 1, further comprising:
receiving, by the media session handler, one or more configurations of the spatial computing session transmitted from the media application function based on the determined session parameters.

4. The method of claim 1, further comprising:
establishing, by the media access function, the spatial computing session with the media application server based on the determined session parameters of the spatial computing session.

5. The method of claim 3, wherein:
the one or more configurations are transmitted to the media session handler and the media application server by the media application function; and
the media application server sets up the spatial computing session based on the one or more configurations.

6. The method of claim 1, wherein the session parameters include at least one of extended reality (XR) spatial description formats, quality of service (QoS) requirements, or spatial computing capabilities of the UE.

7. The method of claim 2, wherein:
the media-aware application, the media session handler, and the media access function are included in the media client, and
the media application server is included in a data network and configured to establish the spatial computing session with the media client.

8. The method of claim 1, wherein the media session handler is configured to set up and manage a plurality of spatial computing sessions associated with the 3D space.

9. The method of claim 1, wherein the media application function is configured to communicate with the media session handler and the media application server.

10. The method of claim 2, further comprising:
configuring, by the media-aware application, an XR runtime of the UE to provide sensor data required by a plurality of spatial computing functions that is to be processed in the media application server.

11. The method of claim 1, wherein the server that includes the media application function is the media application server.

12. The method of claim 1, wherein the server that includes the media application function is different from the media application server.

13. The method of claim 1, wherein the spatial computing session is of spatial computing for augmented reality.

14. An apparatus for setting up a spatial computing session associated with a three-dimensional (3D) space, comprising:
processing circuitry configured to:
transmit, by a spatial computing client of a media client in the apparatus, a spatial computing session request to a media session handler of the media client, the spatial computing session request being configured to request setup of the spatial computing session of spatial computing;
determine, by the media session handler of the apparatus when the media session handler receives the spatial computing session request transmitted from the spatial computing client, server information of a media application server and session parameters associated with the spatial computing session based on communication between the media session handler and a media application function of a server; and
transmit, by the media session handler of the apparatus, the server information and the session parameters to a media access function of the apparatus to instantiate the spatial computing session.

15. The apparatus of claim 14, wherein the spatial computing session request is initiated by a media-aware application of the apparatus that transmits the spatial computing session request to the spatial computing client.

16. The apparatus of claim 14, wherein the processing circuitry is further configured to:
receive, by the media session handler, one or more configurations of the spatial computing session transmitted from the media application function based on the determined session parameters.

17. The apparatus of claim 14, wherein the processing circuitry is further configured to:
establish, by the media access function, the spatial computing session with the media application server based on the determined session parameters of the spatial computing session.

18. The apparatus of claim 16, wherein:
the one or more configurations are transmitted to the media session handler and the media application server by the media application function; and
the media application server sets up the spatial computing session based on the one or more configurations.

19. The apparatus of claim 14, wherein the session parameters include at least one of extended reality (XR) spatial description formats, quality of service (QoS) requirements, or spatial computing capabilities of the apparatus.

20. A non-transitory computer readable storage medium storing instructions which, when executed by at least one processor of a user equipment (UE), cause the at least one processor to perform:
transmitting, by a spatial computing client of a media client in the UE, a spatial computing session request to a media session handler of the media client, the spatial computing session request being configured to request setup of a spatial computing session of spatial computing;
determining, by the media session handler of the UE when the media session handler receives the spatial computing session request transmitted from the spatial computing client, server information of a media application server and session parameters associated with the spatial computing session based on communication between the media session handler and a media application function of a server; and
transmitting, by the media session handler of the UE, the server information and the session parameters to a media access function of the UE to instantiate the spatial computing session.
